(19) United States
(12) Patent Application Publication
(10) Pub. No.: US 2013/0106889 A1
(43) Pub. Date: May 2, 2013

(54) GRAPHICS PROCESSING METHOD AND DEVICES USING THE SAME

(71) Applicants: Hee Jin LEE, Hwaseong-si (KR); Young Gwan KIM, Hwaseong-si (KR); You Sub JUNG, Hwaseong-si (KR); Jong-Hun HAN, Hwaseong-si (KR)

(72) Inventors: Hee Jin LEE, Hwaseong-si (KR); Young Gwan KIM, Hwaseong-si (KR); You Sub JUNG, Hwaseong-si (KR); Jong-Hun HAN, Hwaseong-si (KR)

(73) Assignee: SAMSUNG ELECTRONICS CO., LTD., Suwon-si (KR)

(21) Appl. No.: 13/615,395

(22) Filed: Sep. 13, 2012

(30) Foreign Application Priority Data
Oct. 26, 2011 (KR) 10-2011-0109654

(51) Int. Cl. G09G 5/00

(52) U.S. Cl. 345/582

(57) ABSTRACT

A graphics processing method and devices using the same is provided. The method includes receiving a plurality of texels arranged in a tiled format and rearranging, by a graphics processing unit (GPU), texels into a sequential format. In a tiled format, texels may be arranged in tiles, at least one tile including M×N texels. In the sequential format, the texels may be arranged in a scan line order of a display.

### CROSS-REFERENCE TO RELATED APPLICATION

This application claims priority under 35 U.S.C. §119(a) from Korean Patent Application No. 10-2011-0109654 filed on Oct. 26, 2011, the disclosure of which is hereby incorporated by reference in its entirety.

### BACKGROUND

Embodiments of the present disclosure relate to a graphics processing unit (GPU), and more particularly, to the GPU for reducing the load of a central processing unit (CPU), devices including the same and a method of operating the same.

Power supply is an important issue for handheld devices such as cellular phones or tablet personal computers (PCs). A CPU is used to control the overall operation of these handheld devices.

The CPU reads and executes program instructions to control the operation of the devices. When the CPU reads and executes the program instructions, the load of the CPU may increase. When the load of the CPU increases, power consumption in a device including the CPU also increases, generating heat. Therefore, a method of overcoming the problems of increasing power consumption and heat generation is desired.

### SUMMARY

According to exemplary embodiments of the present disclosure, there is provided a graphics processing method. The method includes receiving a plurality of texels arranged in a tiled format and rearranging, by a graphics processing unit (GPU) the texels in a sequential format.

In a tiled format, the plurality of texels may be arranged in a plurality of tiles, one of the plurality of tiles comprising M×N texels. In the sequential format, the plurality of texels may be arranged in a scan line order of a display.

The rearranging the texels may include reading a look-up table (LUT). A cells of the LUT may be located corresponding to the location of one of the plurality of texels arranged in the tiled format and may contain coordinates of the respective texel of the plurality of texels arranged in the sequential format.

Each of the coordinates of the respective texel of the plurality of texels arranged in the sequential format may be expressed in two dimensions: an x-coordinate and a y-coordinate. The x-coordinate may be a remainder obtained when a value indicating an order of each of the plurality of texels in a sequence is divided by the number of columns of the plurality of texels arranged in the sequential format. The y-coordinate may be a quotient obtained when the value indicating the order of each of the plurality of texels in the sequence is divided by the number of columns of the plurality of texels arranged in the sequential format.

According to other embodiments of the inventive concept, there is provided a graphics processing unit including a texel fetch unit configured to fetch a plurality of texels arranged in a tiled format and a fragment shader configured to rearrange the plurality of texels in a sequential format,

In the tiled format, the plurality of texels may be arranged in a plurality of tiles, one of the plurality of tiles comprising M×N texels. In the sequential format, the plurality of texels may be arranged in a scan line order of a display. The texel fetch unit may fetch a look-up table (LUT). A cell of the LUT may be located corresponding to the location of one of the plurality of texels arranged in the tiled format and may contain coordinates of the respective texel of the plurality of texels arranged in the sequential format. The fragment shader may rearrange the texels from the tiled format into the sequential format using the look-up table.

Each of the coordinates of the respective texels arranged in the sequential format may be expressed in two dimensions: an x-coordinate and a y-coordinate. The x-coordinate may be a remainder obtained when a value indicating an order of each of the plurality of texels in a sequence is divided by the number of columns of texels arranged in the sequential format. The y-coordinate may be a quotient obtained when the value indicating the order of each of the plurality of texels in the sequence is divided by the number of columns of texels arranged in the sequential format.

According to further embodiments of the present disclosure, there is provided an application processor including the above-described graphics processing unit and a memory interface configured to transmit the plurality of texels arranged in the tiled format from a memory unit to the graphics processing unit.

In other embodiments, a data processing system includes the above-described graphics processing unit, a memory unit configured to store the plurality of texels in the tiled format, and a memory interface configured to transmit the plurality of texels arranged in the tiled format from the memory unit to the graphics processing unit.

### BRIEF DESCRIPTION OF THE DRAWINGS

The above and other features and advantages of the inventive concept will become more apparent by describing in detail exemplary embodiments thereof with reference to the attached drawings in which:

FIG. 1 is a block diagram of a data processing system including a graphics processing unit (GPU) according to exemplary embodiments of the present disclosure;

FIG. 2 is a block diagram of the GPU illustrated in FIG. 1;

FIG. 3 shows a plurality of tiles stored in a tiled format in a texture buffer illustrated in FIG. 2;

FIG. 4 shows a plurality of texels included in two tiles among the plurality of tiles illustrated in FIG. 3;

FIG. 5 shows a look-up table used by the GPU illustrated in FIG. 2 to rearrange a plurality of texels received in a tiled format into a sequential format; and

FIG. 6 is a flowchart of a method of operating the GPU illustrated in FIG. 2 according to exemplary embodiments of the present disclosure.

### DETAILED DESCRIPTION

Aspects of exemplary embodiments will now be described more fully hereinafter with reference to the accompanying drawings. This disclosure may, however, be embodied in many different forms and should not be construed as limited to exemplary embodiments set forth herein. Rather, these exemplary embodiments are provided so that this disclosure will be thorough, and will convey the scope of the disclosure to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

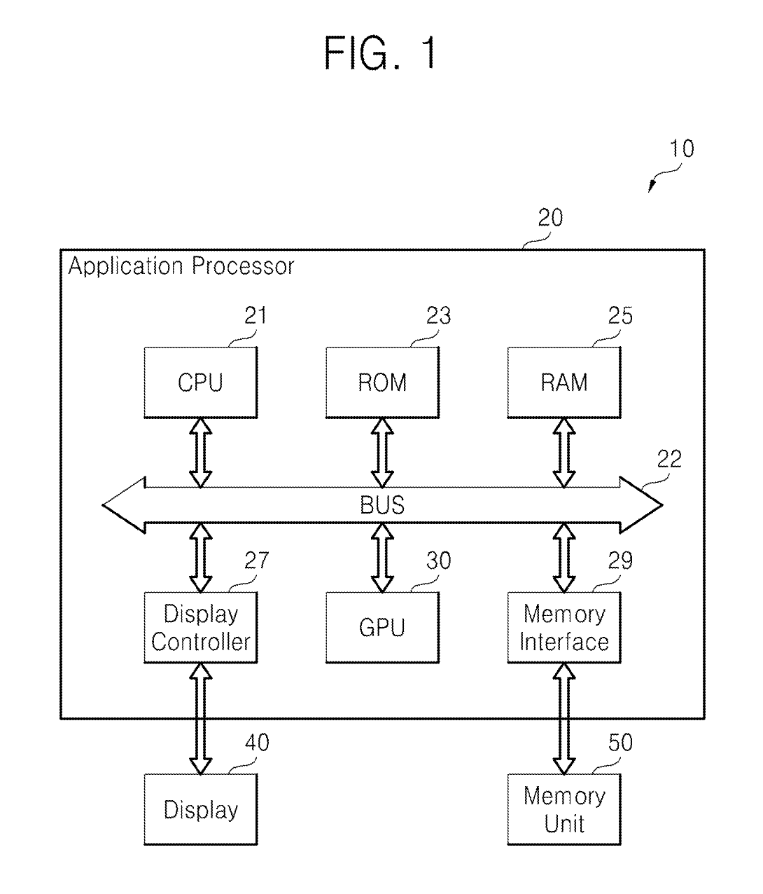

FIG. 1 is a block diagram of a data processing system 10 including a graphics processing unit (GPU) 30, according to exemplary embodiments. Referring to FIG. 1, the data processing system 10 may be implemented as a handheld device such as a cellular telephone, a smart phone, a tablet personal computer (PC), a personal digital assistant (PDA), an enterprise digital assistant (EDA), a digital still camera, a digital video camera, a portable multimedia player (PMP), a personal navigation device or portable navigation device (PND), a handheld game console, an e-book, etc.

The data processing system 10 may include an application processor 20, a display 40 and a memory unit 50.

The application processor 20 may control the overall operation of the data processing system 10. The application processor 20 may include a central processing unit (CPU) 21, a read only memory (ROM) 23, a random access memory (RAM) 25, a display controller 27, a memory interface 29 and the GPU 30. The application processor 20 may be implemented as a system on chip (SoC). The CPU 21 may read and execute program instructions.

The CPU 21 may be implemented as a multi-core processor. The multi-core processor is a single computing component with two or more independent cores.

Programs and/or data stored in the memory 23 or 25 may be loaded to a memory (not shown), e.g., a cache memory, of the CPU 21 when necessary. The ROM 23 may store permanent programs and/or data. The ROM 23 may be implemented by erasable programmable read-only memory (EPROM), electrically erasable programmable read-only memory (EEPROM), etc. The RAM 25 may temporarily store programs, data or instructions. The programs and/or data stored in the memory 23 or 25 may be temporarily stored in the RAM 25 according to the control of the CPU 21, the control of the GPU 30 or a booting code stored in the ROM 23. The RAM 25 may be implemented by dynamic RAM (DRAM) or static RAM (SRAM), etc.

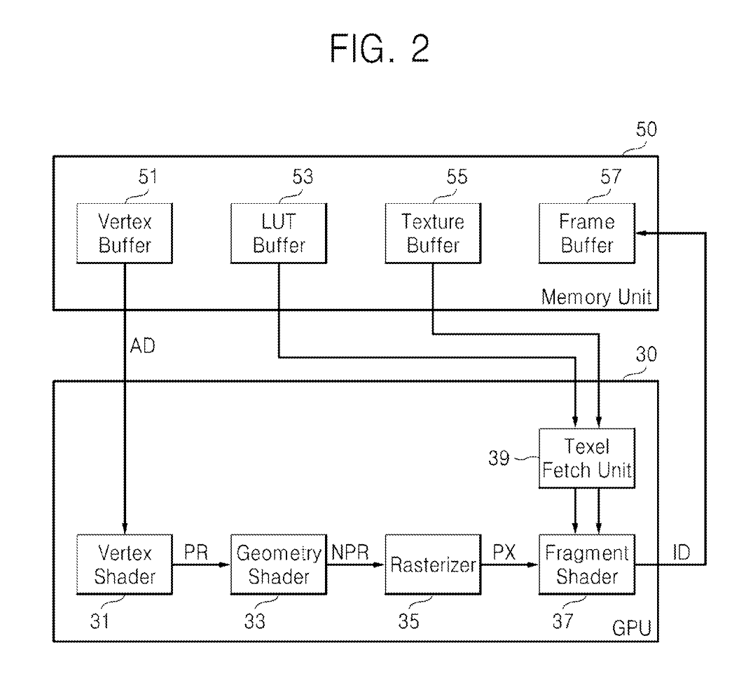

The GPU 30, which is able to reduce the load of the CPU 21, may read and execute program instructions related with graphics processing. The program instructions will be described in detail with reference to FIG. 2 later.

The display controller 27, which is able to control the operation of the display 40, may transmit image data, e.g., moving image data or still image data, from the memory unit 50 to the display 40. The display 40 may be implemented by a liquid crystal display (LCD), a light emitting diode (LED) display, an organic LED (OLED) display, an active matrix OLED (AMOLED) display, etc.

The application processor 20 and the memory unit 50 may communicate with each other through the memory interface 29. The memory interface 29 may function as a memory controller which enables the application processor 20 to access the memory unit 50.

The memory unit 50 may store programs and/or image data which will be processed by the CPU 21 or the GPU 30. The memory unit 50 may be implemented by non-volatile memory. The non-volatile memory may be implemented by flash memory or resistive memory. The elements 21, 23, 25, 27, 29 and 30 may communicate with one another via a bus 22.

FIG. 2 is a block diagram of the GPU 30 illustrated in FIG. 1. Referring to FIGS. 1 and 2, data is transmitted from the memory unit 50 to the GPU 30 and data processed by the GPU 30 is transmitted to the memory unit 50 through the memory interface 29, but the memory interface 29 is omitted for clarity of the description.

The memory unit 50 includes a vertex buffer 51, a look-up table (LUT) buffer 53, a texture buffer 55 and a frame buffer 57.

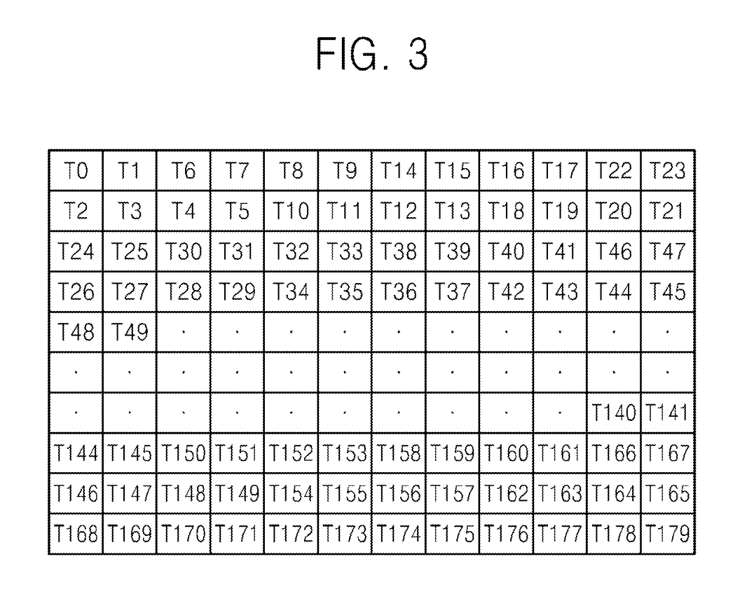

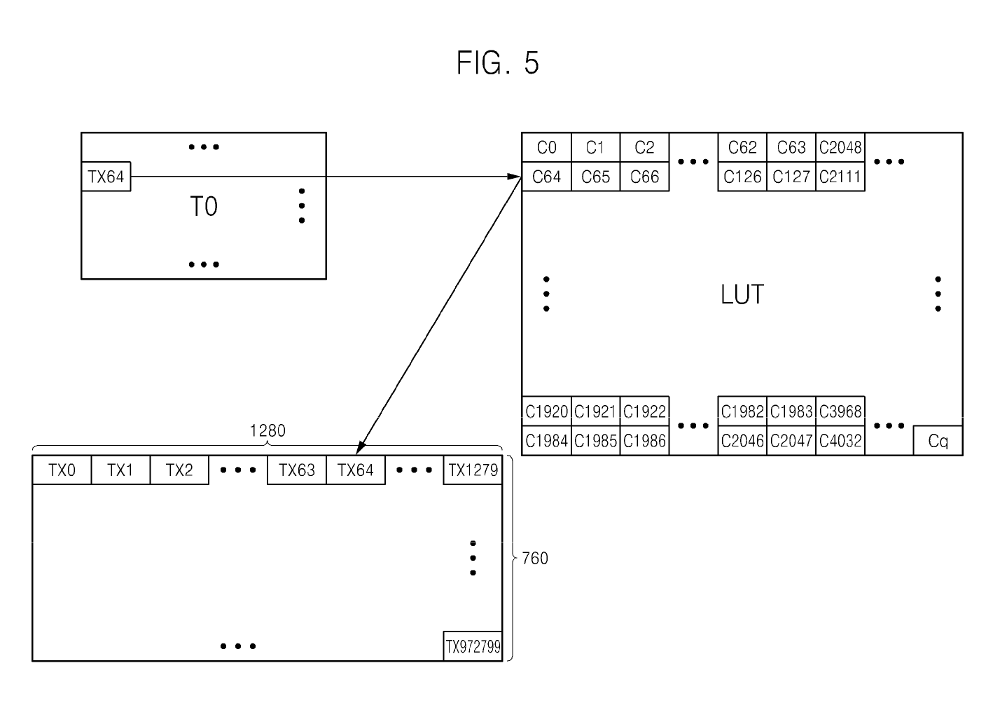

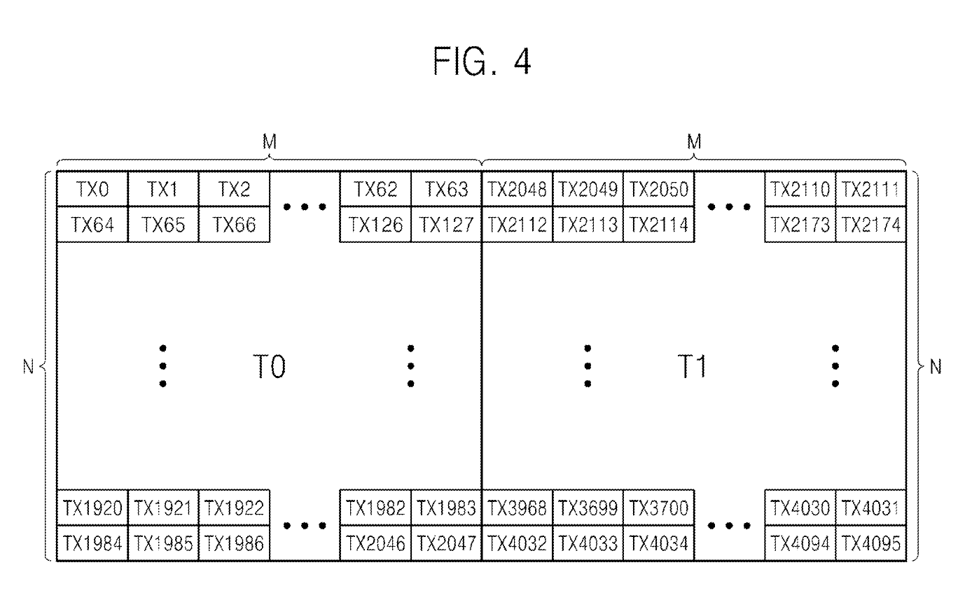

The vertex buffer 51 stores attribute data AD such as the position and the color of a vertex and outputs the attribute data AD to a vertex shader 31. The LUT buffer 53 will be described in detail with reference to FIG. 5 later. The texture buffer 55 will be described in detail with reference to FIGS. 3 and 4 later. The frame buffer 57 stores image data, e.g., moving image data, still image data, three-dimensional (3D) image data or stereoscopic image data, processed by the GPU 30.

The GPU 30 includes the vertex shader 31, a geometry shader 33, a rasterizer 35, a fragment shader 37 and a texel fetch unit 39. The elements 31, 33, 35, 37 and 39 are units that execute a program instruction related to graphics processing.

The vertex shader 31 executes vertex shader program instructions. In detail, the vertex shader 31 receives the attribute data AD such as the position and the color of a vertex from the vertex buffer 51. The vertex shader 31 manipulates the attribute data AD to transform the 3D position of the vertex in virtual space to two-dimensional (2D) coordinates so that the vertex appears on the display 40. The vertex shader 31 generates primitives PR such as points, lines and triangles. A primitive includes vertices.

The geometry shader 33 executes geometry shader program instructions. In detail, the geometry shader 33 adds more vertices to or removes vertices from the primitives PR output from the vertex shader 31, thereby generating new primitives NPR.

The rasterizer 35 executes rasterizer program instructions. In detail, the rasterizer 35 receives the new primitives NPR from the geometry shader 33 and converts the new primitives NPR into a plurality of pixels PX.

The fragment shader 37 executes fragment shader program instructions by performing computation operations processing the pixels PX to calculate final color to be displayed on the display 40. The fragment shader 37 outputs image data ID as a result of processing the pixels PX. The image data ID is stored in the frame buffer 57 and is displayed on the display 40 through the display controller 27.

The computation operations may include texture mapping and color format conversion. The texture mapping is an operation of performing mapping between the pixels PX and “texels” output from the texture buffer 55 in order to add detail to the pixels PX. The color format conversion is an operation of performing conversion from a YUV format into an RGB format so that the image data ID is stored in the frame buffer 57.

In an explanatory embodiment, a texel (shorthand for “texture element”) is the fundamental unit of texture space. Just as an image is represented by an array of pixels, a texture is graphically represented by arrays of texels. A texture may be a bitmap image. The texture may be defined as a set of texels. The texture buffer 55 stores texels in a tiled format. The tiled format will be described below with reference to FIGS. 3 and 4.

Texels may be stored in a variety of arrangements. One arrangement is a “sequential format” where each texel is stored sequentially in the scan line order of the display. For example, the bottom left-hand corner of FIG. 5 shows a display with 1280 columns and 760 rows. Texels TX0 through TX972799 are arranged sequentially in 1280 column and 760 rows.

If the texels are stored in a sequential format in the texture buffer 55 and are transmitted from the texture buffer 55 to the GPU 30, a bottleneck phenomenon may occur. Therefore, texels may be stored in a tiled format.

FIG. 3 shows a plurality of tiles stored in a tiled format in the texture buffer 55 illustrated in FIG. 2. FIG. 4 shows a plurality of texels included in two tiles among the plurality of tiles illustrated in FIG. 3. Referring to FIGS. 1 through 4, the texels are stored in the tiled format in the texture buffer 55. The tiled format is a format in which a plurality of tiles, e.g., T0 through T179, are arranged.

The tiles T0 through T179 may be arranged in various ways. Each of the tiles TO through T179 includes a plurality of texels. For instance, each tile may include M×N texels where M and N are natural numbers and M=N or M≠N.

Here, M indicates a row of texels and N indicates a column of texels. For instance, the tile T0 may include a plurality of texels TX0 through TX2047 and the tile T1 may include a plurality of texels TX2048 through TX4095. The numbers of tiles and texels may vary with embodiments.

Each of the texels TX0 through TX4095 includes texel information. The texel information includes a luma component indicating brightness information and chrominance components indicating color information.

The luma component is defined as Y and the chrominance components are defined as U and V. The value of the luma component and the values of the chrominance components may be in a range between 0 and 1.

As shown in FIG. 4, texels TX0 through TX4095 are stored in the tiled format in the texture buffer 55, and therefore, the speed of texel transmission from the texture buffer 55 to the GPU 30 is increased.

In order to properly display the texture on the display 40, the texels arranged in the tiled format need to be rearranged in the sequential format. This rearrangement can be performed by a CPU or a GPU. Rearranging the texels using the GPU reduces the load on the CPU, thereby reducing power consumption.

As shown in FIG. 2, the texel fetch unit 39 of GPU 30 fetches a plurality of texels from the texture buffer 55. The fragment shader 37 receives the texels arranged in the tiled format from the texel fetch unit 39. The fragment shader 37 rearranges the texels in the sequential format so that the image data ID is properly displayed on the display 40.

FIG. 5 shows a LUT used by the GPU 30 illustrated in FIG. 2 to rearrange a plurality of texels received in the tiled format into a sequential format. Referring to FIGS. 1 through 5, the texel fetch unit 39 fetches the LUT from the LUT buffer 53.

The LUT includes cells C0 through Cq, which are arranged in the same locations as texels TX0 through TX4095 when arranged in the tiled format and contain the coordinates of texels TX0 through TX4095 when arranged in the sequential format. Each of the coordinates in cells C0 through Cq are expressed in two dimensions containing an x-coordinate and a y-coordinate. Each of the x- and y-coordinates may be represented by a plurality of bits.

Similarly, the coordinate of each of the texels TX0 through TX4095 arranged in tiled format is expressed in two dimensions containing an x-coordinate and a y-coordinate. For instance, the coordinate of the texel TX64 included in the tile T0 may be given by (0,1), where “0” indicates the x-coordinate of the tile T0 and “1” indicates the y-coordinate of the tile T0.

The fragment shader 37 receives the plurality of texels arranged in the tiled format from the texel fetch unit 39. For instance, the fragment shader 37 receives the texel TX64 included in the tile T0. The fragment shader 37 reads the coordinate C64 of the texel TX64 in the sequential format, which corresponds to the coordinate of the texel TX64 in the tiled format, from the LUT. The fragment shader 37 rearranges the texel TX64 in the sequential format using the coordinate C64 of the texel TX64.

The x-coordinate of each of a plurality of texels in the sequential format is the remainder obtained when a value indicating the order of each texel in the sequence is divided by the horizontal length of the texels in the sequential format (i.e. the number of columns of texels when in the sequential format). For instance, the x-coordinate of the texel TX64 in the sequential format is a remainder of 64 obtained when a value of 64 indicating the order of the texel TX64 in the sequence is divided by a horizontal length of 1280 of the texels in the sequential format.

The y-coordinate of each of the texels in the sequential format is the quotient obtained when the value indicating the order of each texel in the sequence is divided by the horizontal length of the texels in the sequential format (i.e. the number of columns of texels when in the sequential format). For instance, the y-coordinate of the texel TX64 in the sequential format is a quotient of 0 obtained when the value of 64 indicating the order of the texel TX64 in the sequence is divided by the horizontal length of 1280 of the texels in the sequential format.

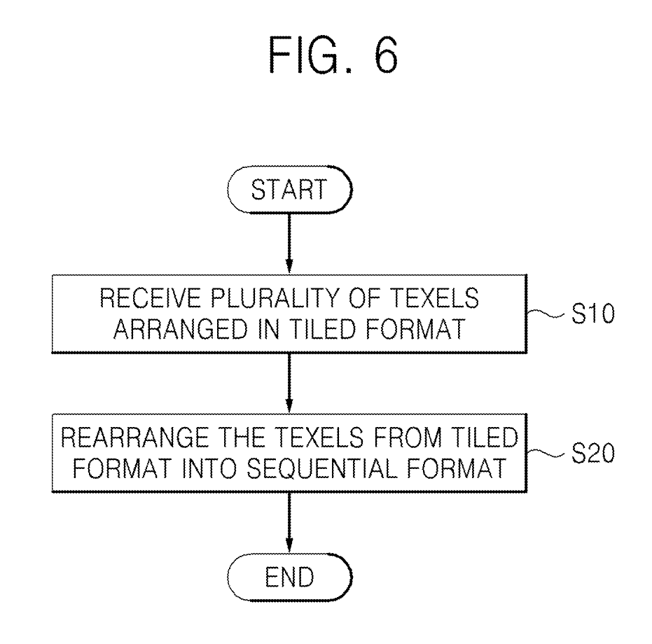

FIG. 6 is a flowchart of a method of operating the GPU 30 illustrated in FIG. 2 according to exemplary embodiments of the present disclosure. Referring to FIGS. 1 through 6, the texel fetch unit 39 fetches a plurality of texels arranged in the tiled format from the texture buffer 55.

The fragment shader 37 receives the texels arranged in the tiled format from the texel fetch unit 39 in operation S10. The fragment shader 37 rearranges the texels from the tiled format into the sequential format in operation S20.

The texel fetch unit 39 fetches the LUT including coordinates of the respective texels arranged in the sequential format, which respectively correspond to coordinates of the texels arranged in the tiled format. The fragment shader 37 reads the LUT and rearranges the texels in the sequential format using the LUT. When the texels in the tiled format is rearranged in the sequential format, the image data ID is properly displayed on the display 40.

In a GPU, devices including the same and a method of operating the same according to exemplary embodiments of the present disclosure, a plurality of texels arranged in a tiled format are rearranged in a sequential format, so that the load of a CPU is reduced. As the load of the CPU is reduced, the power consumption of a device including the CPU and the GPU is decreased. As a result, heat generated in the device is also decreased.

While the present disclosure has been particularly shown and described with reference to exemplary embodiments thereof, it will be understood by those of ordinary skill in the art that various changes in forms and details may be made therein without departing from the spirit and scope of the inventive concept as defined by the following claims.

What is claimed is:

1. A graphics processing method, comprising:
receiving a plurality of texels arranged in a tiled format; and
rearranging, by a graphics processing unit (GPU), the plurality of texels into a sequential format,
wherein, in the tiled format, the plurality of texels are arranged in a plurality of tiles, one of the plurality of tiles comprising M×N texels, and, in the sequential format, the plurality of texels are arranged in a scan line order of a display.

2. The method of claim 1, wherein the rearranging the plurality of texels comprises:
reading a look-up table (LUT) wherein a cell of the LUT is located corresponding to a location of one of the plurality of texels arranged in the tiled format and contains coordinates of the respective texel of the plurality of texels arranged in the sequential format.

3. The method of claim 2, wherein the coordinates of the respective texel of the plurality of texels arranged in the sequential format is expressed in two dimensions including an x-coordinate and a y-coordinate.

4. The method of claim 3, wherein the x-coordinate is a remainder obtained when a value indicating an order of the respective texel of the plurality of texels in a sequence is divided by a number of columns of the plurality of texels arranged in the sequential format.

5. The method of claim 3, wherein the y-coordinate is a quotient obtained when a value indicating an order of the respective texel of the plurality of texels in a sequence is divided by a number of columns of the plurality of texels arranged in the sequential format.

6. The method of claim 1, further comprising controlling the GPU by a central processing unit (CPU).

7. A graphics processing unit (GPU) comprising:
a texel fetch unit configured to fetch a plurality of texels arranged in a tiled format; and
a fragment shader configured to rearrange the plurality of texels in a sequential format,
wherein, in the tiled format, the plurality of texels are arranged in a plurality of tiles, one of the plurality of tiles comprising M×N texels, and, in the sequential format, the plurality of texels are arranged in a scan line order of a display.

8. The GPU of claim 7, wherein the texel fetch unit fetches a look-up table (LUT) wherein a cell of the LUT is located corresponding to a location of one of the plurality of texels arranged in tiled format and contains coordinates of the respective texel of the plurality of texels arranged in the sequential format.

9. The GPU of claim 8, wherein the fragment shader rearranges the plurality of texels from the tiled format into the sequential format using the LUT.

10. The GPU of claim 8, wherein each of the coordinates of the respective texels arranged in the sequential format is expressed in two dimensions:
an x-coordinate comprising a remainder obtained when a value indicating an order of the respective texel of the plurality of texels in a sequence is divided by a number of columns of the plurality of texels arranged in the sequential format, and
a y-coordinate comprising a quotient obtained when the value indicating the order of the respective texel of the plurality of texels in the sequence is divided by the number of columns of the plurality of texels arranged in the sequential format.

11. An application processor comprising:
the GPU of claim 7; and
a memory interface configured to transmit the plurality of texels arranged in the tiled format from a memory unit to the GPU.

12. The application processor of claim 11, wherein the texel fetch unit fetches a look-up table (LUT) wherein a cell of the LUT is located corresponding to a location of one of the plurality texels arranged in tiled format and contains coordinates of the respective texel of the plurality of texels arranged in the sequential format.

13. The application processor of claim 12, wherein the fragment shader rearranges the texels from the tiled format into the sequential format using the LUT.

14. A data processing system comprising:
the GPU of claim 7;
a memory unit which stores the plurality of texels in the tiled format; and
a memory interface configured to transmit the plurality of texels arranged in the tiled format from the memory unit to the GPU.

15. The data processing system of claim 14, wherein the texel fetch unit fetches a look-up table (LUT) wherein a cell of the LUT is located corresponding to a location of one of the plurality of texels arranged in tiled format and contains coordinates of the respective texel of the plurality of texels arranged in the sequential format, and the fragment shader rearranges the texels from the tiled format into the sequential format using the look-up table.

16. The data processing system of claim 15, further comprising a central processing unit (CPU) which controls the operation of the GPU.

17. A mobile handheld device, comprising:
a central processing unit (CPU);
a graphics processing unit (GPU) which reads and executes programs related to graphics processing;
a display controller which outputs image data processed by the GPU to a display unit of the mobile handheld device;
wherein the GPU fetches a plurality of texels arranged in a tiled format and rearranges the plurality of texels in a sequential format,
wherein, in the tiled format, the plurality of texels are arranged in a plurality of tiles, one of the plurality of tiles comprising M×N texels, and, in the sequential format, the plurality of texels are arranged in a scan line order of a display.

18. The mobile handheld device of claim 17, wherein the GPU fetches a look-up table (LUT) wherein a cell of the LUT is located corresponding to a location of one of the plurality of texels arranged in tiled format and contains coordinates of the respective texel of the plurality of texels arranged in the sequential format.

19. The mobile handheld device of claim 18, wherein each of the coordinates of the respective texels arranged in the sequential format is expressed in two dimensions:
an x-coordinate comprising a remainder obtained when a value indicating an order of the respective texel of a plurality of texels in a sequence is divided by a number of columns of the plurality of texels arranged in the sequential format, and
a y-coordinate comprising a quotient obtained when the value indicating the order of the respective texel of a plurality of texels in the sequence is divided by the number of columns of the plurality of texels arranged in the sequential format.

20. The mobile handheld device of claim 17, further comprising
a memory unit which stores the plurality of texels in the tiled format; and
a memory interface configured to transmit the plurality of texels arranged in the tiled format from the memory unit to the GPU.
